(19) United States
(12) Patent Application Publication
(10) Pub. No.: US 2004/0234241 A1
(43) Pub. Date: Nov. 25, 2004

(54) Hard disk recorder

(76) Inventor: Mitsuhiko Kawasaki, Osaka (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/849,773

(22) Filed: May 21, 2004

(30) Foreign Application Priority Data
May 21, 2003 (JP) 2003-143536

(51) Int. Cl. H04N 5/781

(52) U.S. Cl. 386/83; 386/125

(57) ABSTRACT

A hard disk recorder stores time data relating to recording on a hard disk when the recording is completed. A main CPU in the recorder determines whether two or more of the same pieces of recording time data are stored on the hard disk. If such pieces of data are found, the main CPU creates a recording time list and stores the list in a memory. By using the recording time list created in the above manner to program the recorder, a user can easily select desired recording time data as information for timer activated recording.

### BACKGROUND OF THE INVENTION

1. Field of the Invention

The present invention relates to hard disk recorders for recording television (TV) programs delivered in the form of TV broadcasting signals in a hard disk drive (referred to as a HDD, hereinafter).

2. Description of the Related Art

Hard disk recorders are known which receive TV broadcasting signals to record audio and video (AV) signals contained in the TV broadcasting signals in an internal HDD. Such a recorder has the programming capability of automatically recording a user selected program based on information entered by the user in advance, but the programming process is cumbersome and time consuming.

In order to simplify the programming process, a variety of attempts have been made. For example, a known recorder has a one-touch timer recording function which allows a user to set the recording stop time with a simple operation when starting the recording. An apparatus is also known which stores selection information once entered for programming with the information being classified by type of program, so that subsequent programming with the same selection can be easily implemented only by specifying the type of the program to be recorded and retrieving the selection information for transfer to a memory (see, for example, Japanese patent laid-open publication No. SHO 64-55767).

Further, there are known apparatus which use program information, typified by electronic program guide (EPG), to facilitate the programming process (see, for example, Japanese patent laid-open publication Nos. 2001-160256 and 2001-56983).

However, the above recorder having the one-touch timer recording function is inconvenient in that it fails to allow the recording start time to be preset, so that a user cannot program the recorder until the start time is reached. In the apparatus disclosed in the Japanese patent laid-open publication No. SHO 64-55767, it is hard to perform programming on the basis of recording time because the selection information is classified by type of program for storage. In the apparatus disclosed in the Japanese patent laid-open publication Nos. 2001-160256 and 2001-56983, it is required the program information such as the EPG or the like. Without the program information, they must be programmed according to the ordinary complicated procedure.

### SUMMARY OF THE INVENTION

The present invention has been made to solve the above mentioned problems, and an object of the present invention is to provide a hard disk recorder in which, if the number of recording conducted based on the same time information exceeds a predetermined number, programming after that can be easily carried out by using the recording time information.

An aspect of the present invention provides a hard disk recorder comprising: a receiver for receiving broadcasting signals of television programs; an encoder for encoding the broadcasting signals received by the receiver; a hard disk drive for recording the broadcasting signals encoded by the encoder; recording control means for controlling recording by the hard disk drive, based on time information entered by a user for programming the hard disk recorder to record a television program; and a storage device for storing recording time data when recording is completed under the control of the recording control means; the recording control means including: recording time list creating means for, when recording is completed, comparing recording time data relating to the recording with pieces of recording time data having been stored in the storage device to determine whether there is a piece of recording time data that is identical to said recording time data, and, if at least a predetermined number of the same pieces of recording time data are present, creating a time list containing said recording time data for storage; and programming means for displaying the time list created by the recording time list creating means on a display connected to the hard disk recorder when a specific key is operated by a user so that the user can select desired recording time data from the time list, and storing the selected recording time data as information for timer activated recording, wherein the recording control means controls the recording based on the recording time data stored in the programming means.

By such a configuration, when the number of recording conducted in accordance with the same time information exceeds a predetermined number, a recording time list is created relating to the recording time information. By using the created recording time list to program the recorder, a user can easily select desired recording time data in the list as information for timer activated recording which should be performed later. Thus, the user can program the recorder through procedure simple compared to ordinary programming procedure without the need to wait until the recording start time is reached, which is required in the conventional recorder having the one-touch timer recording function.

Preferably, in the hard disk recorder, either a channel being tuned when recording time data is selected by a user or a channel to be tuned at recording start time is stored as information for timer activated recording.

Preferably, the recording time data in the recording time list is arranged in the order of time to be displayed, so that desired recording time data can be easily retrieved.

### BRIEF DESCRIPTION OF THE DRAWINGS

FIG. 1 is a block diagram of a hard disk recorder according to one embodiment of the present invention.

FIG. 2 is a flowchart showing the process of creating a recording time list in the recorder.

FIG. 3 is a flowchart showing the process executed in the recorder when the recorder is programmed to perform timer activated recording.

FIG. 4 is a conceptual drawing illustrating recording time data stored on the hard disk in the recorder.

FIG. 5 is a drawing illustrating a recording time list selection screen in the recorder.

### DETAILED DESCRIPTION OF THE PREFERRED EMBODIMENT

### Embodiment 1

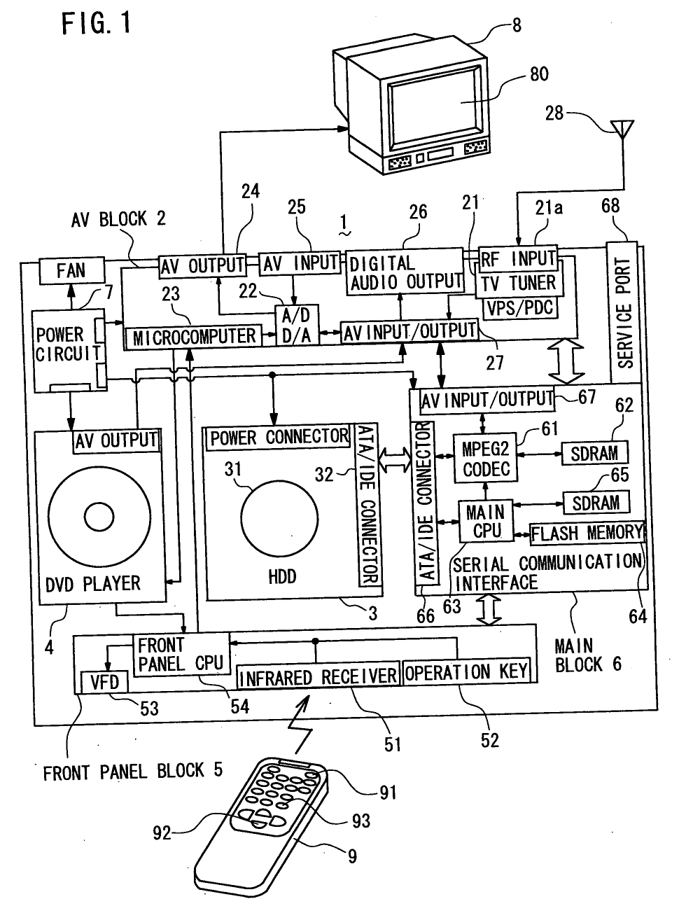

Referring now to the accompanying drawings, a hard disk recorder according to one embodiment of the present invention will be described. FIG. 1 is a block diagram of the hard disk recorder. This hard disk recorder 1 includes an AV block 2 for input and output of AV signals, a hard disk drive 3 for recording AV signals on a hard disk 31, a DVD player 4 for reproducing AV signals recorded on a DVD, a front panel block 5 placed at the front panel of the hard disk recorder 1 for functioning as an interface across which a user operates the hard disk recorder 1, a main block 6 for encoding and decoding AV signals while controlling each block in the hard disk recorder 1, and a power circuit 7 for electric supply to each block. The hard disk recorder 1 is adapted to record broadcasting signals including AV signals transmitted from a TV station, for example, on the hard disk 31 for later replay.

The AV block 2 includes a TV tuner (receiver) 21 for receiving television broadcasting signals, a signal processing section 22 for converting between digital and analog AV signals, a microcomputer 23 for controlling each component within the AV block 2, an AV output 24, an AV input 25, a digital audio output 26, and an AV input/output 27. The TV tuner 21 has a RF input 21a connected to an antenna 28 and receives AV signals as well as VPS signals and PDC signals, which are used for program selection, from a TV station. The signal processing section 22 converts digital AV signals received via the AV input/output 27 into analog signals for output via the AV output 24 to a display 8. The signal processing section 22 also converts analog AV signals received via the AV input 25 from external to the hard disk recorder 1 into digital signals for output to the AV input/output 27. The microcomputer 23 controls each component within the AV block 2 while communicating with a front panel CPU 54 and a main CPU 63 as the need arises. When a recording time list, which will be described below, is to be displayed, the microcomputer 23 causes on screen display (OSD) signals to be superimposed on AV signals.

The hard disk drive 3 has the hard disk 31 of 40 GB platter therein and records AV signals compression-encoded within the main block 6 and recording time data relating to recorded programs on the hard disk (storage device) 31. The interface of the hard disk drive 3 is in conformity with ATA/IDE standards. The hard disk drive 3 and the main block 6 are connected to each other via respective ATA/IDE connectors 32 and 66.

The front panel block 5 includes an infrared receiver 51 for receiving infrared signals transmitted from a remote controller 9, operation keys 52 for a user to directly enter an operator command, a vacuum fluorescent display (VFD) 53 for displaying the operating status of the hard disk recorder 1, and the front panel CPU 54 for controlling each component within the front panel block 5. The front panel block 5 functions as an interface between the hard disk recorder 1 and a user. More particularly, a user can direct the hard disk recorder 1 to select recording time data from a recording time list, to record a television program, or to play back a recorded file by operating the operation keys 52 or the remote controller 9 while viewing the display on the VFD 53 or the display 8. A user selects desired recording time data from a recording time list by pressing a history button (specific key) 91 so that the list is displayed on the display 8, operating a cursor key 92 to move a cursor 82 on the display 8, and pressing an enter key 93.

The main block 6 includes a CODEC (encoder) 61 for compression and encoding or decompression and decoding of AV signals according to the Moving Picture Experts Group Phase 2 (MPEG-2), a memory (SDRAM) 62 for temporarily storing AV signals encoded or decoded by the CODEC 61, the main CPU 63 for controlling each component of the hard disk recorder 1, a flash memory 64 in which an operation program for the main CPU 63 is stored, a memory (SDRAM) 65 for storing created recording time list and information relating to selection made to program the recorder for timer activated recording, an ATA/IDE connector 66, an AV input/output 67, and a service port 68. The memories 62 and 65 may be a single memory which can be divided into segments. The main CPU 63 operates based on a predetermined operating system (OS) such as, for example, Vx Works. The main CPU 63 controls recording operations (recording control means) and creates a recording time list for storage in the memory 65 (recording time list creating means), and causes timer activated recording to be performed based on information stored in the memory 65 by programming means, which will be described below. Further, the main CPU 63 not only controls the CODEC 61 but also controls other components in the hard disk recorder 1 via communication with the hard disk drive 3, the microcomputer 23 which controls the AV block 2, and the front panel CPU 54 which controls the front panel block 53, each of which is connected with the main CPU 63.

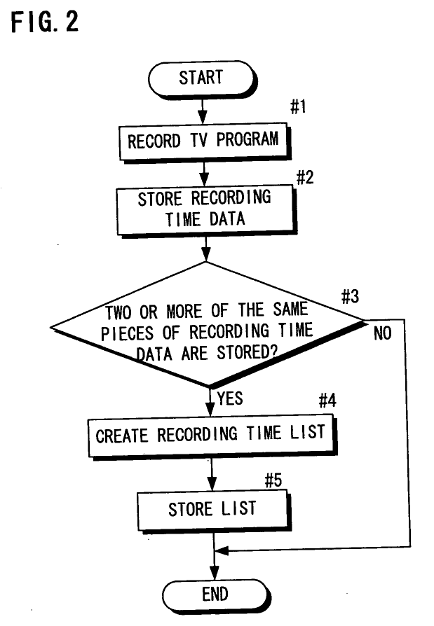

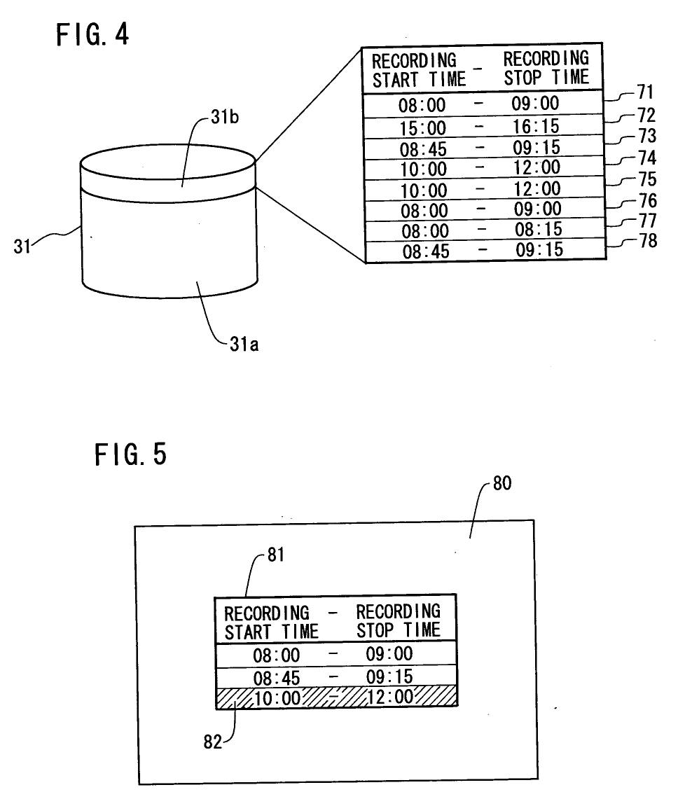

Referring now to the flowchart of FIG. 2, a description will be made as to the process to be executed by the main CPU 63 for creating a recording time list. The main CPU 63 controls a recording process based on information entered by a user so that a user-selected television program is recorded (#1). Upon completion of the recording, the main CPU 63 stores time data relating to the recording on the hard disk 31 (#2). It should be noted that recording time data is to be stored relating to not only timer activated recording but also ordinary recording. FIG. 4 schematically shows recording time data stored on the hard disk 31. As can been seen from FIG. 4, the hard disk 31 stores AV signals in a storage area 31a while storing recording time data in a storage area 31b. Each of pieces of recording time data 71 to 78 includes recording start time information and recording stop time information. The main CPU 63 determines whether two or more of the same pieces of recording time data are stored on the hard disk 31. If such pieces of data are stored (YES at #3), the main CPU 63 creates a recording time list (#4) and stores the list in the memory 65 (#5). The recording time list may be created in the case where the number of pieces of recording time data that are identical to each other exceeds a predetermined number, for example, three. Such number may be fixed or may be user programmable. If there are no pieces of recording time data that are identical to each other (NO at #3), the main CPU 63 terminates the process without creating any recording time list. In the example shown in FIG. 4, the pieces of recording time data 71, 73, and 74 correspond to the pieces of data 76, 78, and 75, respectively, and thus they are stored in the memory 65 as a recording time list.

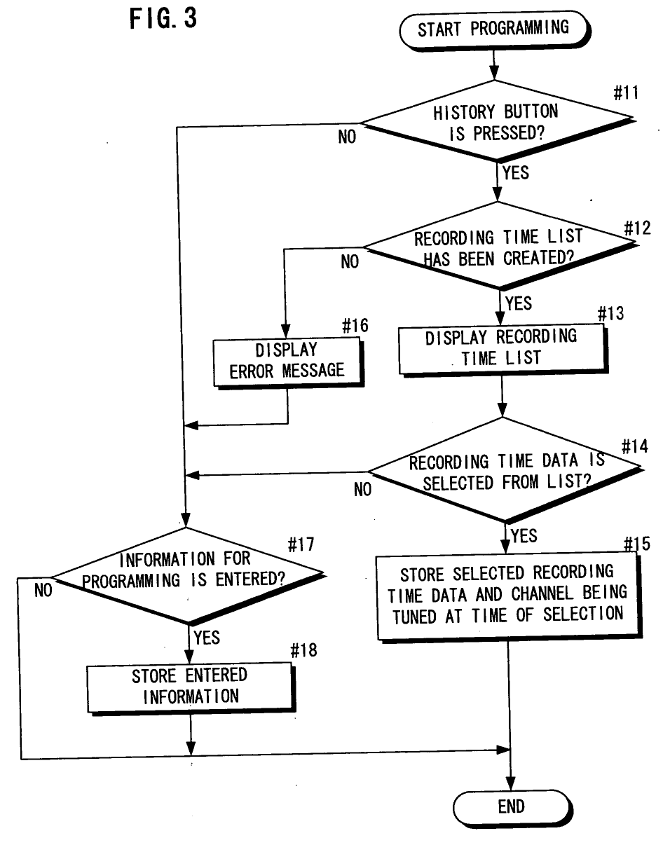

Referring to the flowchart of FIG. 3, a description will be made as to the process executed by the main CPU 63 when the recorder is programmed for timer activated recording by using a recording time list. For programming the recorder using a recording time list, a user presses the history button 91. In response to depression of the history button 91 (YES at #11), the main CPU 63 determines whether or not a recording time list has been created, and if the list has been created (YES at #12), the main CPU 63 directs the microcomputer 23 to display the recording time list, in which recording time data is arranged in the order of time, superimposed on AV signals on the display 8 (#13). If no recording time list has been created (NO at #12), the main CPU 63 directs the microcomputer 23 to display an error message (#16) so that programming is carried out according to ordinary procedure.

FIG. 5 illustrates a recording time list 81 displayed on a screen 80 of the display 8, where the pieces of recording time data having corresponding pieces of data in FIG. 4 are shown. When the user moves the cursor 82 and selects desired recording time data by operating the remote controller 9 or the operation keys 52 (YES at #14), the selected recording time data is stored in the memory 65. When recording a television program, the channel to be tuned should be specified. In this embodiment, a channel being tuned at the time of selection of recording time data from a recording time list is stored as information for timer activated recording in the memory 65, associated with the selected recording time data, and thus the programming is completed (programming means) (#15). If the recording time list has been created but desired recording time data is not found in the list (NO at #14), the user enters information for programming according to ordinary procedure (YES at #17), and thus the programming is completed (#18). In such a case, if no information for programming is entered (NO at #17), the process is terminated without programming of the recorder.

The main CPU 63 controls recording process based on the information for timer activated recording that is stored in the memory 65, so that recording of the program on the selected channel is initiated at the recording start time and terminated at the recording stop time. Since this recorder uses the hard disk drive 3 which is randomly accessible, a recorded program can be played back while another program is being recorded. Further, the recorder can be programmed to record a program and perform the recording during playback of another program having been previously recorded. Although selected as a channel to be recorded is a channel being tuned at the time of selection of recording time data from a recording time list, the channel to be recorded is not fixed but can be changed until the recording is initiated, while recording of unintended program can be prevented which may be caused by channel changes before the start time is reached. Even in the case where the power switch in the recorder is off, if the power circuit 7 is connected to the power supply, it feeds a current through the main block 6, so that the main CPU 63 can initiate the recording on the selected channel when the recording start time is reached.

### Embodiment 2

This Embodiment 2 is different from Embodiment 1 in how to select a channel to be recorded when programming is carried out, but the configuration of each block in the hard disk recorder, the process of creating a recording time list, and the method of selecting recording time data using the recording time list are similar to those in Embodiment 1. In this embodiment, timer activated recording of a television program is performed on a channel being tuned at the time of start of the recording. A main CPU 63 controls recording process based on recording time data stored in a memory 65 so as to initiate, at the record start time, recording of the program on a channel being tuned at that time and terminate the recording at the recording stop time. After the recording is initiated, the channel to be recorded is inhibited from change. Even if the power switch in the recorder is off, a channel having been tuned just before the recorder is switched off is stored in the memory 65, so that the main CPU 63 can start the recording on the channel when the recording start time is reached.

### Embodiment 3

This Embodiment 3 is different from Embodiments 1 and 2 in how to select a channel to be recorded when programming is carried out, but the configuration of each block in the hard disk recorder, the process of creating a recording time list, and the method of selecting recording time data using the recording time list are similar to those in Embodiment 1. In this embodiment, a user selects, as a channel to be recorded, either a channel being tuned when recording time data is selected from a recording time list or a channel being tuned when recording is initiated by using a remote controller 9. The channel selection is stored as information for timer activated recording in a memory 65, associated with the recording time data. Thus, the programming is completed. Even in the case where the power switch in the recorder is off before the recording start time, a main CPU 63 can start recording on the selected channel when the recording start time is reached, in the same manner as Embodiment 1 or 2.

This application is based on Japanese patent application 2003-143536 filed in Japan dated May 21, 2003, the contents of which are hereby incorporated by references.

Although the present invention has been described above using a presently preferred embodiments, those skilled in the art will appreciate that various modifications are possible. Accordingly, all such modifications are intended to be included within the sprit and scope of the present invention. For example, AV signals recorded on the hard disk 31 may be signals compressed according to MPEG-4 or other standards in place of the signals compressed according to MPEG-2. Alternatively, in order to record and reproduce images and sounds of high quality, non-compressed digital signals may be recorded.

A channel to be recorded may be freely selected by a user when the recorder is programmed. Recording time data in a recording time list may be arranged in the order of frequency of recording for display. The storage medium for storing recording time data and the storage medium for storing a recording time list and information for timer activated recording are not limited to the hard disk 31 and the memory 65, respectively, but they may be any storage medium in the hard disk recorder 1. The OSD process may be controlled not by the microcomputer 23 but by the main CPU 63 for example.

What is claimed is:

1. A hard disk recorder comprising:
a receiver for receiving broadcasting signals of television programs;
an encoder for encoding the broadcasting signals received by the receiver;
a hard disk drive for recording the broadcasting signals encoded by the encoder;
recording control means for controlling recording by the hard disk drive, based on time information entered by a user for programming the hard disk recorder to record a television program; and
a storage device for storing recording time data when recording is completed under the control of the recording control means;
the recording control means including:
recording time list creating means for, when recording is completed, comparing recording time data relating to the recording with pieces of recording time data having been stored in the storage device to determine whether there is a piece of recording time data that is identical to said recording time data, and, if at least a predetermined number of the same pieces of recording time data are present, creating a time list containing said recording time data for storage; and
programming means for displaying the time list created by the recording time list creating means on a display connected to the hard disk recorder when a specific key is operated by a user so that the user can select desired recording time data from the time list, and storing the selected recording time data as information for timer activated recording, wherein the recording control means controls the recording based on the recording time data stored in the programming means.

2. The hard disk recorder according to claim 1,
wherein the programming means stores the recording time data and a channel being tuned at the time of selection of the recording time data as the information for timer activated recording.

3. The hard disk recorder according to claim 2,
wherein, when the programming means displays the time list created by the recording time list creating means on the display connected to the hard disk recorder, the recording time data in the time list is given in the order of recording time.

4. The hard disk recorder according to claim 1,
wherein the programming means stores the recording time data and a channel to be tuned at recording start time as the information for timer activated recording.

5. The hard disk recorder according to claim 4,
wherein, when the programming means displays the time list created by the recording time list creating means on the display connected to the hard disk recorder, the recording time data in the time list is given in the order of recording time.
